(19) United States
(12) Patent Application Publication
(10) Pub. No.: US 2026/0364474 A1
(43) Pub. Date: Nov. 19, 2026

(54) METHOD AND DEVICE FOR INTERACTING WITH VIRTUAL FIREARM, STORAGE MEDIUM, AND ELECTRONIC DEVICE

(71) Applicant: NETEASE (HANGZHOU) NETWORK CO., LTD., Hangzhou, Zhejiang (CN)

(72) Inventor: Yangchen JIANG, Hangzhou, Zhejiang (CN)

(73) Assignee: NETEASE (HANGZHOU) NETWORK CO., LTD., Hangzhou, Zhejiang (CN)

(21) Appl. No.: 19/121,147

(22) PCT Filed: Mar. 24, 2023
(86) PCT No.: PCT/CN2023/083854

§ 371 Date: Apr. 15, 2025

(30) Foreign Application Priority Data
Oct. 18, 2022 (CN) 202211274167.8

(51) Int. Cl. A63F 13/837; A63F 13/2145; A63F 13/5372; G06F 3/0485; G06F 3/0488

(52) U.S. Cl. CPC A63F 13/837; A63F 13/2145; A63F 13/5372; G06F 3/0485; G06F 3/0488; A63F 2300/308

(57) ABSTRACT

Provided in the embodiments of the present disclosure are a method for interacting with a virtual firearm, including: obtaining the number of initial ammunition items of the virtual firearm, wherein a graphical user interface is provided by a terminal device, the graphical user interface at least partially displays a virtual scene and a reload control, and the virtual scene includes a virtual object; in response to determining that the number of initial ammunition items is greater than a first preset value, and in response to detecting a first touch operation on the reload control, merging a first quantity of initial ammunition items into a first ammunition item; and in response to detecting a use operation on the first ammunition item, controlling the virtual firearm to interact, through the first ammunition item, with the virtual object in the virtual scene.

### CROSS-REFERENCE TO RELATED APPLICATION

The present disclosure is a U.S. National Stage Application of International Application No. PCT/CN2023/083854, filed on Mar. 24, 2023, which is based upon and claims the priority to the Chinese Patent Application NO. 202211274167.8, entitled “METHOD AND DEVICE FOR INTERACTING WITH VIRTUAL FIREARM, STORAGE MEDIUM, AND ELECTRONIC DEVICE”, filed on Oct. 18, 2022, the entire contents of which are incorporated herein by reference for all purposes.

### TECHNICAL FIELD

The present disclosure relates to the field of virtual interaction technologies, and in particular to a method for interacting with a virtual firearm, a device for interacting with a virtual firearm, a non-transitory computer-readable storage medium, and an electronic device.

### BACKGROUND

A virtual scene may include a virtual character, and a user may control the virtual character to hold a virtual firearm and shoot with the virtual firearm to interact with other virtual objects in the virtual scene. A result of the interaction may include a change in an attribute, such as a health point attribute.

The current shooting interaction scheme is to use the virtual firearm to perform the shooting interaction with the virtual object based on existing ammunitions, and the effect achieved by each interaction is exactly the same.

It should be noted that the information disclosed in the background section above is only used to enhance the understanding of the background of the present disclosure, and therefore may include information that does not constitute the prior art known to those skilled in the art.

### SUMMARY

A first aspect of embodiments of the present disclosure provides a method for interacting with a virtual firearm, including: obtaining the number of initial ammunition items of the virtual firearm, wherein a graphical user interface is provided by a terminal device, the graphical user interface at least partially displays a virtual scene and a reload control, and the virtual scene comprises a virtual object; in response to determining that the number of initial ammunition items is greater than a first preset value, and in response to detecting a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and in response to a use operation on the first ammunition item, controlling the virtual firearm to interact, through the first ammunition item, with the virtual object in the virtual scene.

According to a second aspect of embodiments of the present disclosure, there is provided a non-transitory computer-readable storage medium having a computer program stored thereon, which, when executed by a processor, implements the method for interacting with the virtual firearm of the first aspect of the above embodiments.

According to a third aspect of embodiments of the present disclosure, there is provided an electronic device, including: one or more processors; a storage device, configured to store one or more programs, which, when executed by the one or more processors, cause the one or more processors to implement the method for interacting with the virtual firearm of the first aspect of the above embodiments.

It should be understood that the above general description and the following detailed description are merely exemplary and explanatory, and should not limit the present disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 schematically shows a schematic diagram of an example terminal device to which a method for interacting with a virtual firearm and a device for interacting with a virtual firearm according to an embodiment of the present disclosure can be applied;

FIG. 2 schematically shows a flowchart of a method for interacting with a virtual firearm according to an embodiment of the present disclosure;

FIG. 3 schematically shows a schematic diagram of an interface of a first quantity selection control including a plurality of quantity nodes according to an embodiment of the present disclosure;

FIG. 4 schematically shows a schematic diagram of an interface of highlighting an adjustable area in a preset manner according to an embodiment of the present disclosure;

FIG. 5 schematically shows a schematic diagram of an interface of displaying a synthesis control and switching a reload control to a cancel control according to an embodiment of the present disclosure;

FIG. 6 schematically shows a schematic diagram of an interface of displaying a split control and switching a reload control to a cancel control according to an embodiment of the present disclosure;

FIG. 7 schematically shows a schematic diagram of an interface of visually displaying a value of a duration according to an embodiment of the present disclosure;

FIG. 8 schematically shows a schematic diagram of an application scenario in an example embodiment of the present disclosure;

FIG. 9 schematically shows a structural block diagram of a device for interacting with a virtual firearm according to an embodiment of the present disclosure; and

FIG. 10 schematically shows a schematic structural diagram of a computer system suitable for implementing a terminal device according to an embodiment of the present disclosure.

### DETAILED DESCRIPTION

Example embodiments will now be described more fully with reference to the accompanying drawings. However, the example embodiments may be implemented in a variety of forms and should not be construed as being limited to examples set forth herein; rather, these embodiments are provided so that the present disclosure will be more complete and comprehensive so as to comprehensively convey the concept of the example embodiments to those skilled in this art. In the description below, numerous specific details are set forth to provide a thorough understanding of embodiments of the present disclosure. However, those skilled in the art will appreciate that the technical solution of the present disclosure may be practiced without one or more of the specific details, or other methods, components, devices, steps and the like may be employed. In other instances, well-known technical solutions are not shown or described in detail to avoid obscuring various aspects of the present disclosure.

In addition, the drawings are merely schematic illustrations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

As described above, a virtual scene may include a virtual character, and a user may control the virtual character to hold a virtual firearm and shoot with the virtual firearm to interact with other virtual objects in the virtual scene. A result of the interaction may include a change in an attribute, such as a health point attribute.

The current shooting interaction scheme is to use the virtual firearm to perform the shooting interaction with the virtual object based on existing ammunitions, and the effect achieved by each interaction is exactly the same.

In the above scheme, the user can only perform interaction using the virtual firearm based on fixed ammunitions. For a user with proficient shooting skills, multiple interactions are required to achieve a good cumulative effect; or for a user with rusty shooting skills, ammunitions are easily wasted and more interactions cannot be achieved for practice or other purposes.

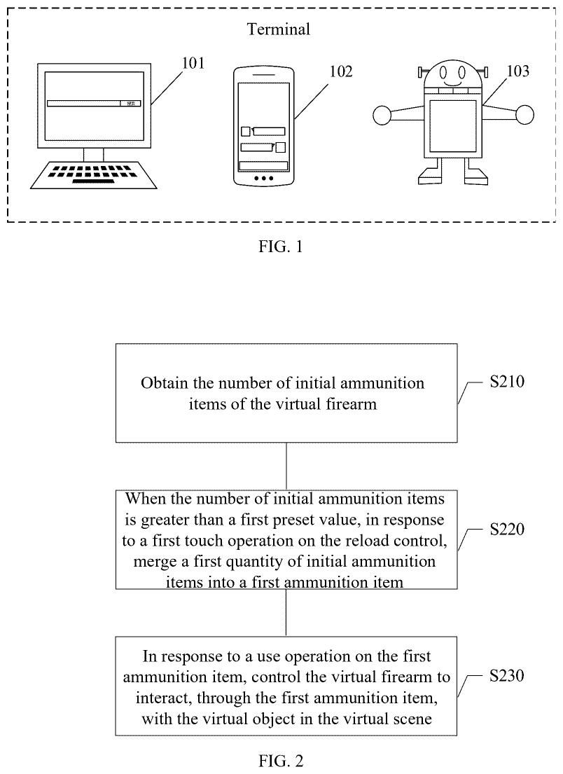

FIG. 1 shows a schematic diagram of an example terminal device to which a method for interacting with a virtual firearm and a device for interacting with a virtual firearm according to an embodiment of the present disclosure can be applied.

As shown in FIG. 1, the terminal device may include one or more of terminal devices 101, 102, and 103. The terminal devices 101, 102, and 103 may be various electronic devices with display screens, including but not limited to desktop computers, portable computers, smart phones, and tablet computers.

The method for interacting with the virtual firearm in embodiments of the present disclosure can be run on a local terminal device or a server. When the method for interacting with the virtual firearm is run on the server, the method can be implemented and executed based on a cloud interaction system, and the cloud interaction system includes the server and a client device.

In an implementation, various cloud applications, such as cloud gaming, can be run in the cloud interaction system. Taking the cloud gaming as an example, the cloud gaming refers to a game mode based on cloud computing. In an operation mode of cloud gaming, an operating body of a game program and a main body of the game screen presentation are separated. The storage and operation of the method for interacting with the virtual firearm are completed on the cloud gaming server. The client device is used for receiving and sending data and presenting the game screen. For example, the client device can be a display device with data transmission function close to the user side, such as a mobile terminal, a TV, a computer, a handheld computer, etc.; but the cloud gaming server in the cloud is used for information processing. When playing the game, a player operates the client device to send an operation instruction to the cloud gaming server. The cloud gaming server runs the game according to the operation instruction, encodes and compresses the game screen and other data, and returns it to the client device through the network. Finally, the client device decodes and outputs the game screen and other data.

In an implementation, taking a game as an example, a local terminal device stores a game program and is used to present a game screen. The local terminal device is used to interact with the player through a graphical user interface, that is, the game program is conventionally downloaded and installed through the terminal device and run. The local terminal device may provide the graphical user interface to the player in a variety of ways, for example, the graphical user interface may be rendered and displayed on a display screen of the terminal, or provided to the player through a holographic projection. For example, the local terminal device may include the display screen and a processor, the display screen is used to present the graphical user interface, the graphical user interface includes a game screen, and the processor is used to run the game, generate the graphical user interface, and control the display of the graphical user interface on the display screen.

It should be noted that a computer-readable storage medium shown in the present disclosure may be a computer-readable signal medium or a computer-readable storage medium or any combination of the above two. In the present disclosure, the computer-readable signal medium may include a data signal propagated in a baseband or as part of a carrier wave, which carries a computer-readable program code. The computer-readable storage medium may be included in the terminal device described in the above embodiments; or it may exist alone without being assembled into the terminal device. The computer-readable storage medium carries one or more programs, which, when executed by the terminal device, enable the terminal device to implement the method in the following embodiments. For example, the terminal device can implement various steps shown in FIG. 2, etc.

In an embodiment of the present disclosure, the virtual scene may be a digital scene drawn by an intelligent terminal device such as a computer, a mobile phone, or a tablet computer through digital communication technologies. The digital scene may be displayed on the display screen of the intelligent terminal device or may be projected onto other display devices. The virtual scene can include buildings or structures such as houses, buildings, gardens, bridges, pools, etc., and can also include natural landscapes such as mountains, rivers, lakes, and any virtual items such as weapons, tools, and creatures, which is not specifically limited in the embodiment. The virtual character is a three-dimensional model created based on animation skeleton technologies. Each virtual character has its own shape and volume in a three-dimensional virtual environment and occupies a part of the space in the three-dimensional virtual environment.

A virtual scene screen presented by the graphical user interface may be, for example, a game screen, which is taken by a virtual camera provided in the virtual scene. The virtual camera may obtain the virtual scene screen based on a first perspective, a second perspective, or another perspective, such as a bird's-eye view, which is a perspective of observing the virtual environment from an aerial perspective. When the bird's-eye view is used, the virtual camera may be located above the virtual scene. Depending on a height of the virtual camera, when the height of the virtual camera is low, the acquired screen may only be a part of the virtual scene, such as a Multiplayer Online Battle Arena (MOBA); and when the height of the virtual camera is high, the acquired screen may be the whole of the virtual scene.

The embodiment provides a method for interacting with a virtual firearm. Referring to FIG. 2, a graphical user interface is provided by a terminal device, the graphical user interface at least partially displays a virtual scene and a reload control, and the virtual scene includes a virtual object. The method includes:
in step S210, the number of initial ammunition items of a virtual firearm is obtained;
in step S220, when the number of initial ammunition items is greater than a first preset value, in response to a first touch operation on a reload control, a first quantity of initial ammunition items is merged into a first ammunition item, the first quantity is less than or equal to the number of initial ammunition items, and an attack power of the first ammunition item is higher than an attack power of the initial ammunition item; and
in step S230, in response to a use operation on the first ammunition item, the virtual firearm is controlled to interact, through the first ammunition item, with the virtual object in the virtual scene.

By implementing the method for interacting with the virtual firearm shown in FIG. 2, the number of initial ammunition items of the virtual firearm can be obtained; when the number of initial ammunition items is greater than the first preset value, in response to the first touch operation on the reload control, the first quantity of initial ammunition items is merged into the first ammunition item; and in response to the use operation on the first ammunition item, the virtual firearm is controlled to interact, through the first ammunition item, with the virtual object in the virtual scene. In embodiments of the present disclosure, on the one hand, when the number of ammunition items is greater than the first preset value, the ammunition items can be merged to enhance a preset shooting property of the virtual firearm, thereby achieving a better interaction effect without a large number of interactive operations, and improving the interaction efficiency; on the other hand, the user can define an interaction mode of the virtual firearm, avoiding the interaction in a single fixed mode, thereby improving the flexibility and freedom of the interaction process.

The above steps of the embodiment are described in more detail below.

In the step S210, the number of initial ammunition items of the virtual firearm is obtained.

In an embodiment of the present disclosure, the virtual firearm is a virtual item, and the user can control, through the terminal device, the virtual character in the virtual scene to use the virtual item. The ammunition item is an item associated with the virtual firearm, for example, the number of ammunition items limits the number of times the virtual firearm can shoot, and a type of ammunition item matches a specific virtual firearm.

It can be understood that, similar to the virtual firearm and ammunition, virtual longbows and arrows are naturally applicable to embodiments of the present disclosure, along with other virtual item combinations employing analogous usage patterns, which are not limited by embodiments of the present disclosure here.

It should be noted that the number of initial ammunition items of the virtual firearm may refer to the number of ammunition items that have been loaded into the virtual firearm or its magazine, or the number of ammunition items stored in a virtual warehouse or virtual backpack, which are not limited by embodiments of the present disclosure here.

In the step S220, when the number of initial ammunition items is greater than the first preset value, in response to the first touch operation on the reload control, the first quantity of initial ammunition items is merged into the first ammunition item, the first quantity is less than or equal to the number of initial ammunition items, and the attack power of the first ammunition item is higher than the attack power of the initial ammunition item.

In an embodiment of the present disclosure, the first preset value may be a value configured according to actual needs. For example, it may be 1 or 4. When the first preset value is 1, if the number of ammunition items is 2 or greater than 2, the ammunition items can be synthesized.

The reload control may be configured to, in response to a single-click touch operation, update the number of ammunitions loaded in the virtual firearm to the maximum capacity value, and correspondingly reduce the number of ammunition items in the virtual warehouse or virtual backpack; and in response to the first touch operation on the reload control, merge the first quantity of initial ammunition items into the first ammunition items. The first quantity is less than or equal to the number of initial ammunition items, and the attack power of the first ammunition item is higher than the attack power of the initial ammunition item.

For example, the first touch operation on the reload control is a long-press touch operation on the reload control. For example, the first quantity may be determined according to a duration of the long-press touch operation; when the duration is 1 second, the first quantity may be 1, and when the duration is 2 seconds, the first quantity may be 2. After the merge is completed, the first quantity of initial ammunition items is reduced, and the first ammunition item is increased.

In an embodiment of the present disclosure, when the duration reaches a preset duration, the first quantity of initial ammunition items is merged into the first ammunition items.

In an embodiment of the present disclosure, the attack power of the first ammunition item is higher than the attack power of the initial ammunition item. For example, two initial ammunition items are synthesized into one first ammunition item. When the virtual firearm interacts with the virtual object based on the initial ammunition item, the health point attribute of the virtual object can be reduced by 20, and when the virtual firearm interacts with the virtual object based on the first ammunition item, the health point attribute of the virtual object can be reduced by 40.

In the step S230, in response to the use operation on the first ammunition item, the virtual firearm is controlled to interact, through the first ammunition item, with the virtual object in the virtual scene.

In an embodiment of the present disclosure, in response to the use operation on the first ammunition item, the virtual firearm is controlled to interact, through the first ammunition item, with the virtual object in the virtual scene. During the interaction, a hit judgment algorithm can be used to generate a ray according to a shooting angle and orientation of the virtual firearm, calculate an intersection of the ray and the virtual object of the virtual scene, and determine the hit virtual object according to the intersection. Alternatively, other hit algorithms are used to determine the hit virtual object, and interact with the virtual object in the virtual scene through the first ammunition item in the virtual firearm. For example, a moving speed attribute value of the virtual object may be caused to decrease or a health attribute value of the virtual object may be caused to decrease. The configuration can be performed according to actual needs. Embodiments of the present disclosure do not limit the interaction effect here.

In an embodiment of the present disclosure, when the number of initial ammunition items is greater than the first preset value, in response to the first touch operation on the reload control, a first quantity selection control is displayed on the graphical user interface; in response to a user operation, a target node is determined from a plurality of quantity nodes; and the first quantity of initial ammunition items is merged into the first ammunition item according to the first quantity corresponding to the target node. When the number of initial ammunition items is greater than the first preset value, in response to the first touch operation on the reload control, merging the first quantity of initial ammunition items into the first ammunition item may include steps S310 to S330.

In the step S310, when the number of initial ammunition items is greater than the first preset value, in response to the first touch operation on the reload control, the first quantity selection control is displayed on the graphical user interface, and the first quantity selection control includes the plurality of quantity nodes.

In the step S320, in response to the user operation, the target node is determined from the plurality of quantity nodes.

In the step S330, the first quantity of initial ammunition items is merged into the first ammunition item according to the first quantity corresponding to the target node.

In an embodiment of the present disclosure, when the number of initial ammunition items is greater than the first preset value, in response to the first touch operation on the reload control, the first quantity selection control is displayed on the graphical user interface. The first quantity selection control may be a bar control, and the first quantity selection control may be arranged with quantity nodes in sequence. For example, the quantity nodes may correspond to a positive integer 1, 2, 3 . . . , and the largest positive integer of the quantity nodes may be used to indicate the number of initial ammunition items. For example, if the number of initial ammunition items is 4, then the first quantity selection control includes 4 nodes.

The first touch operation on the reload control may be a continuous left-right swiping touch operation while pressing the reload control, so as to move left-right on the first quantity selection control to select different quantity nodes. A movable cursor may also be displayed on the graphical user interface, and the cursor may be controlled, in response to the left-right swiping touch operation, to move on the first quantity selection control to select different quantity nodes.

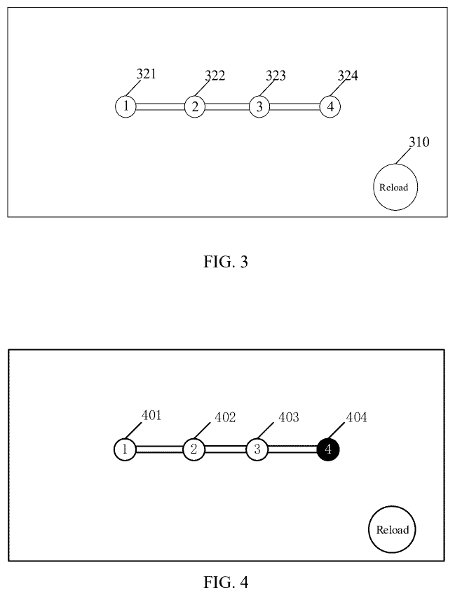

For example, as shown in FIG. 3, the graphical user interface includes a reload control 310, a first quantity node 321, a second quantity node 322, a third quantity node 323, and a fourth quantity node 324, and the four quantity nodes are sequentially arranged on the first quantity selection control.

Through the above steps S310 to S330, when the number of initial ammunition items is greater than the first preset value, in response to the first touch operation on the reload control, the first quantity selection control is displayed on the graphical user interface; in response to the user operation, the target node is determined from the plurality of quantity nodes; and the first quantity of initial ammunition items is merged into the first ammunition item according to the first quantity corresponding to the target node.

In an embodiment of the present disclosure, in response to the first touch operation on the reload control, a synthesis control may be displayed; and in response to the touch operation on the synthesis control, the first quantity selection control is displayed on the graphical user interface. In response to the first touch operation on the reload control, displaying the first quantity selection control on the graphical user interface may include steps S410 to S420.

In the step S410, in response to the first touch operation on the reload control, the synthesis control is displayed.

In the step S420, in response to the touch operation on the synthesis control, the first quantity selection control is displayed on the graphical user interface.

In an embodiment of the present disclosure, the synthesis control may be displayed in response to the first touch operation on the reload control. Specifically, when the first touch operation on the reload control is received, the synthesis control may be displayed on the graphical user interface. The synthesis control may be used to receive the touch operation to display the first quantity selection control on the graphical user interface.

It should be noted that the present disclosure does not specifically limit the specific form of the synthesis control.

Furthermore, only when the initial ammunition item is of a target ammunition type, or only when the virtual firearm is of a target firearm type, the synthesis control can be displayed in response to the first touch operation on the reload control.

In an embodiment of the present disclosure, in response to a swiping operation on the synthesis control, the target node may be determined from the plurality of quantity nodes. Specifically, the synthesis control may include a plurality of quantity nodes, and the target node may be determined from the plurality of quantity nodes, thereby determining a specific value of the first quantity.

It should be noted that the present disclosure does not specifically limit the specific method of determining the target node from the plurality of quantity nodes.

Through the above steps S410 to S420, in response to the first touch operation on the reload control, the synthesis control may be displayed; and in response to the touch operation on the synthesis control, the first quantity selection control is displayed on the graphical user interface.

In an embodiment of the present disclosure, according to a maximum ammunition item capacity of the virtual firearm, a plurality of quantity nodes corresponding to the maximum ammunition item capacity can be displayed in the first quantity selection control, and an adjustable area is highlighted in a preset manner. Displaying the first quantity selection control on the graphical user interface can include steps S510 to S520.

In the step S510, according to the maximum ammunition item capacity of the virtual firearm, the plurality of quantity nodes corresponding to the maximum ammunition item capacity are displayed in the first quantity selection control.

In the step S520, the adjustable area is highlighted in the preset manner.

In an embodiment of the present disclosure, according to the maximum ammunition item capacity of the virtual firearm, the plurality of quantity nodes corresponding to the maximum ammunition item capacity may be displayed in the first quantity selection control. The plurality of quantity nodes include the same number of adjustable nodes as the initial ammunition items, and the adjustable nodes correspond to the adjustable area.

Specifically, based on the display of the first quantity selection control, the adjustable area may be highlighted in the preset manner.

For example, as shown in FIG. 4, the maximum ammunition item capacity is 4, but the number of ammunition items that can be currently used for merging is 3. A first quantity node 401, a second quantity node 402, and a third quantity node 403 are displayed in a light color, and a fourth quantity node 404 is displayed in a dark color, so as to highlight the adjustable area in the preset manner.

Through the above steps S510 to S520, according to the maximum ammunition item capacity of the virtual firearm, the plurality of quantity nodes corresponding to the maximum ammunition item capacity can be displayed in the first quantity selection control, and the adjustable area is highlighted in the preset manner. Through embodiments of the present disclosure, the quantity for merging and the maximum quantity can be graphically displayed in the first quantity selection control, which allows the user to intuitively understand the synthesis process, thereby improving the interaction efficiency.

In an embodiment of the present disclosure, in response to the swiping operation on the synthesis control, a candidate target node may be determined from the plurality of quantity nodes; a duration of the swiping operation on the graphical user interface after the candidate target node is determined is obtained; and when the duration is greater than or equal to a value corresponding to the candidate target node, the candidate target node is determined as the target node. In response to the swiping operation on the synthesis control, determining the target node from the plurality of quantity nodes may include steps S610 to S630.

In the step S610, in response to the swiping operation on the synthesis control, the candidate target node is determined from the plurality of quantity nodes, and the plurality of quantity nodes include the candidate target node.

In the step S620, the duration of the swiping operation on the graphical user interface after the candidate target node is determined is obtained.

In the step S630, when the duration is greater than or equal to the value corresponding to the candidate target node, the candidate target node is determined as the target node.

In an embodiment of the present disclosure, in the process of determining the target node, the candidate target node is first determined from the plurality of quantity nodes, and then the candidate target node is determined as the target node according to the duration, after the candidate target node is determined, of the swiping operation on the graphical user interface. For example, a second node from left to right in the first quantity selection control can be determined as the candidate target node, and the duration of the swiping operation on the graphical user interface after the candidate target node is determined is obtained. When the swiping operation remains unchanged for two seconds, the candidate target node is then determined as the target node.

Through the above steps S610 to S630, in response to the swiping operation on the synthesis control, the candidate target node can be determined from the plurality of quantity nodes; the duration of the swiping operation on the graphical user interface after the candidate target node is determined is obtained; and when the duration is greater than or equal to the value corresponding to the candidate target node, the candidate target node is determined as the target node.

In an embodiment of the present disclosure, in response to a duration of the first touch operation on the reload control being longer than a preset duration, the synthesis control is displayed and the reload control is switched to a cancel control, and the cancel control is configured to cancel a merging process in response to a touch operation on the cancel control.

For example, in response to the first touch operation on the reload control being a long-press touch operation, when it is determined that a duration of the long-press touch operation is greater than the preset duration, such as 2 seconds, the synthesis control is displayed and the reload control is switched to the cancel control. The synthesis control may be displayed close to the cancel control.

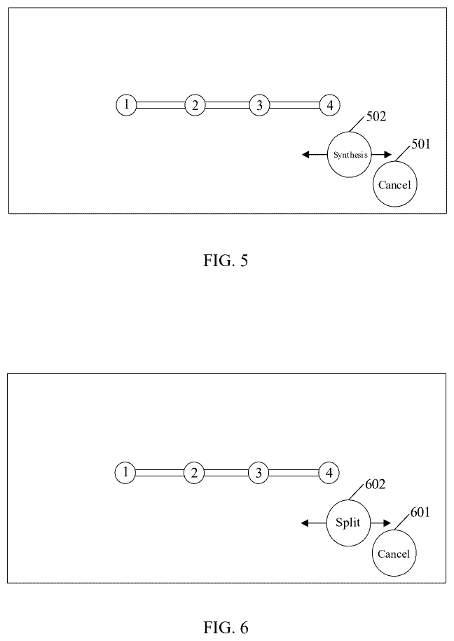

For example, as shown in FIG. 5, a cancel control 501 is displayed in response to the duration of the first touch operation on the reload control being longer than the preset duration, and a synthesis control 502 is generated and displayed at the same time, and in response to a touch operation on the cancel control 501 again, the merging process is cancelled.

In an embodiment of the present disclosure, when the number of initial ammunition items in the virtual firearm is equal to the maximum ammunition item capacity of the virtual firearm, the initial ammunition items in the virtual firearm are merged into the first ammunition items. The number of initial ammunition items in the virtual firearm is the first quantity. Specifically, when the number of initial ammunition items in the virtual firearm reaches the maximum ammunition item capacity of the virtual firearm, all initial ammunition items in the virtual firearm can be merged into the first ammunition items.

In an embodiment of the present disclosure, the attack power of the first ammunition item is associated with the first quantity. Specifically, the attack power of the first ammunition item may be in direct proportion to the first quantity.

In an embodiment of the present disclosure, in response to the first touch operation on the reload control, the first quantity of initial ammunition items is merged into a plurality of first ammunition items according to a preset merging manner. The preset merging manner is used to indicate the number of initial ammunition items required for merging into one first ammunition item. For example, the preset merging manner is to merge every two initial ammunition items into one first ammunition item. For example, if there are 12 initial ammunition items in total, the 12 initial ammunition items can be merged into 6 first ammunition items.

It should be noted that the present disclosure does not specifically limit the specific form of the preset merging manner.

In an embodiment of the present disclosure, in response to the first touch operation on the reload control, the first quantity of initial ammunition items may be merged into a plurality of first candidate ammunition items; and in response to a third touch operation on the reload control, the plurality of first candidate ammunition items are merged into the first ammunition item. In response to the first touch operation on the reload control, merging the first quantity of initial ammunition items into the first ammunition item may include steps S710 to S720.

In the step S710, in response to the first touch operation on the reload control, the first quantity of initial ammunition items is merged into the plurality of first candidate ammunition items.

In the step S720, in response to the third touch operation on the reload control, the plurality of first candidate ammunition items are merged into the first ammunition item.

In an embodiment of the present disclosure, in response to the first touch operation on the reload control, the first quantity of initial ammunition items may be merged into the plurality of first candidate ammunition items, and in response to the third touch operation on the reload control, the plurality of first candidate ammunition items may be merged into the first ammunition item. Specifically, the first quantity of initial ammunition items may be first merged into the plurality of first candidate ammunition items, and then the plurality of first candidate ammunition items may be merged into the first ammunition item.

For example, there are 12 initial ammunition items in total. The 12 initial ammunition items can be merged into 6 first candidate ammunition items, and then the 6 first candidate ammunition items can be generated into 3 first ammunition items.

It should be noted that the present disclosure does not specifically limit the specific manner of merging the first quantity of initial ammunition items into the plurality of first candidate ammunition items and merging the plurality of first candidate ammunition items into the first ammunition item.

Through the above steps S710 to S720, in response to the first touch operation on the reload control, the first quantity of initial ammunition items may be merged into the plurality of first candidate ammunition items; and in response to the third touch operation on the reload control, the plurality of first candidate ammunition items are merged into the first ammunition item.

In an embodiment of the present disclosure, there is a synthesis time corresponding to merging the first quantity of initial ammunition items into the first ammunition item, and the first quantity is directly proportional to the synthesis time. Specifically, the larger the value corresponding to the first quantity, the longer the synthesis time required to merge the first quantity of initial ammunition items into the first ammunition item; and the smaller the value corresponding to the first quantity, the shorter the synthesis time required to merge the first quantity of initial ammunition items into the first ammunition item.

In an embodiment of the present disclosure, when the number of initial ammunition items is less than a second preset value, in response to a second touch operation on the reload control, the initial ammunition item is split into a second quantity of second ammunition items; and in response to a use operation on a second ammunition item, the virtual firearm is controlled to interact, through the second ammunition item, with the virtual object in the virtual scene. Steps S810 to S820 may be included.

In the step S810, when the number of initial ammunition items is less than the second preset value, in response to the second touch operation on the reload control, the initial ammunition item is split into the second quantity of second ammunition items, the second quantity is less than or equal to the maximum ammunition item capacity of the virtual firearm, and an attack power of the second ammunition items is lower than the attack power of the initial ammunition item.

In an embodiment of the present disclosure, the second preset value may be a value configured according to actual needs. For example, the second preset value may be 2, that is, the number of initial ammunition items is 1, and in this case, one initial ammunition item may be split.

The reload control may be configured to, in response to the single-click touch operation, update the number of ammunitions loaded in the virtual firearm to the maximum capacity value, and correspondingly reduce the number of ammunition items in the virtual warehouse or virtual backpack; and in response to the second touch operation on the reload control, split the initial ammunition item into the second ammunition items. The second quantity is less than or equal to the maximum ammunition item capacity in the virtual firearm, and the attack power of the second ammunition item is lower than the attack power of the initial ammunition item.

For example, the second touch operation on the reload control is a long-press touch operation on the reload control. For example, the second quantity can be determined according to a duration of the long-press touch operation; and when the duration is 2 seconds, the second quantity can be 2. After the split is completed, the initial ammunition item is deleted and the second ammunition item is added.

In an embodiment of the present disclosure, when the duration reaches a preset duration, the initial ammunition item is split into a preset number of second ammunition items.

In an embodiment of the present disclosure, the attack power of the second ammunition item is lower than the attack power of the initial ammunition item. For example, the initial ammunition item is split into two second ammunition items. When the virtual firearm interacts with the virtual object based on the initial ammunition item, the health point attribute of the virtual object can be reduced by 40; and when the virtual firearm interacts with the virtual object based on the second ammunition item, the health point attribute of the virtual object can be reduced by 20.

In the step S820, in response to the use operation on the second ammunition item, the virtual firearm is controlled to interact, through the second ammunition item, with the virtual object in the virtual scene.

In an embodiment of the present disclosure, in response to the use operation on the second ammunition item, the virtual firearm is controlled to interact, through the second ammunition item, with the virtual object in the virtual scene. During the interaction, a hit judgment algorithm can be used to generate a ray according to a shooting angle and orientation of the virtual firearm, calculate an intersection of the ray and the virtual object of the virtual scene, and determine the hit virtual object according to the intersection. Alternatively, other hit algorithms are used to determine the hit virtual object, and interact with the virtual object in the virtual scene through the second ammunition item in the virtual firearm. For example, a moving speed attribute value of the virtual object may be caused to decrease or a health attribute value of the virtual object may be caused to decrease. The configuration can be performed according to actual needs. Embodiments of the present disclosure do not limit the interaction effect here.

Through the above steps S810 to S820, when the number of initial ammunition items is less than the second preset value, in response to the second touch operation on the reload control, the initial ammunition item is split into the second quantity of second ammunition items; and in response to the use operation on the second ammunition item, the virtual firearm is controlled to interact, through the second ammunition item, with the virtual object in the virtual scene.

In an embodiment of the present disclosure, when the number of initial ammunition items is less than the second preset value, in response to the second touch operation on the reload control, a second quantity selection control is displayed on the graphical user interface; in response to a user operation, a target node is determined from a plurality of quantity nodes; and according to a second quantity corresponding to the target node, the initial ammunition item is split into the second quantity of second ammunition items. When the number of initial ammunition items is less than the second preset value, in response to the second touch operation on the reload control, splitting the initial ammunition item into the second quantity of second ammunition items may include steps S910 to S930.

In the step S910, when the number of initial ammunition items is less than the second preset value, in response to the second touch operation on the reload control, the second quantity selection control is displayed on the graphical user interface, and the second quantity selection control includes the plurality of quantity nodes.

In the step S920, in response to the user operation, the target node is determined from the plurality of quantity nodes.

In the step S930, according to the second quantity corresponding to the target node, the initial ammunition item is split into the second quantity of second ammunition items.

In an embodiment of the present disclosure, when the number of initial ammunition items is less than the second preset value, in response to the second touch operation on the reload control, the second quantity selection control is displayed on the graphical user interface. The second quantity selection control can be a bar control, and the second quantity selection control is arranged with quantity nodes in sequence. For example, the quantity nodes can correspond to a positive integer 1, 2, 3 . . . , and the largest positive integer of the quantity nodes can be used to indicate the number of second ammunition items to be split into.

The second touch operation on the reload control may be a continuous left-right swiping touch operation while pressing the reload control, so as to move left-right on the second quantity selection control to select different quantity nodes. A movable cursor may also be displayed on the graphical user interface, and the cursor may be controlled, in response to the left-right swiping touch operation, to move on the second quantity selection control to select different quantity nodes.

Through the above steps S910 to S930, when the number of initial ammunition items is less than the second preset value, in response to the second touch operation on the reload control, the second quantity selection control is displayed on the graphical user interface; in response to the user operation, the target node is determined from the plurality of quantity nodes; and according to the second quantity corresponding to the target node, the initial ammunition item is split into the second quantity of second ammunition items.

In an embodiment of the present disclosure, in response to the second touch operation on the reload control, a split control may be displayed; and in response to a touch operation on the split control, the second quantity selection control is displayed on the graphical user interface. In response to the second touch operation on the reload control, displaying the second quantity selection control on the graphical user interface may include steps S1010 to S1020.

In the step S1010, in response to the second touch operation on the reload control, the split control is displayed.

In the step S1020, in response to the touch operation on the split control, the second quantity selection control is displayed on the graphical user interface.

In an embodiment of the present disclosure, in response to the second touch operation on the reload control, the split control may be displayed. Specifically, when the second touch operation on the reload control is received, the split control may be displayed on the graphical user interface. The split control may be used to receive the touch operation to display the second quantity selection control on the graphical user interface.

It should be noted that the present disclosure does not specifically limit the specific form of the split control.

Furthermore, only when the initial ammunition item is of a target ammunition type, or only when the virtual firearm is of a target firearm type, the split control can be displayed in response to the second touch operation on the reload control.

In an embodiment of the present disclosure, the second quantity selection control may be displayed on the graphical user interface in response to the touch operation on the split control. Specifically, the split control may include a plurality of quantity nodes, and the target node may be determined from the plurality of quantity nodes to determine a specific value of the second quantity.

It should be noted that the present disclosure does not specifically limit the specific method of determining the target node from the plurality of quantity nodes.

Through the above steps S1010 to S1020, in response to the second touch operation on the reload control, the split control may be displayed; and in response to the touch operation on the split control, the second quantity selection control is displayed on the graphical user interface.

In an embodiment of the present disclosure, in response to a swiping operation on the split control, a candidate target node may be determined from the plurality of quantity nodes; a duration of the swiping operation on the graphical user interface after the candidate target node is determined is obtained; and when the duration is greater than or equal to a value corresponding to the candidate target node, the candidate target node is determined as the target node. In response to the swiping operation on the split control, determining the target node from the plurality of quantity nodes may include steps S1110 to S1130.

In the step S1110, in response to the swiping operation on the split control, the candidate target node is determined from the plurality of quantity nodes.

In the step S1120, the duration of the swiping operation on the graphical user interface after the candidate target node is determined is obtained.

In the step S1130, when the duration is greater than or equal to the value corresponding to the candidate target node, the candidate target node is determined as the target node.

In an embodiment of the present disclosure, in the process of determining the target node, the candidate target node is first determined from the plurality of quantity nodes, and then the candidate target node is determined as the target node according to the duration of the swiping operation on the graphical user interface after the candidate target node is determined. For example, a second node from left to right in the second quantity selection control can be determined as the candidate target node, and the duration of the swiping operation on the graphical user interface after the candidate target node is determined is obtained. When the swiping operation remains unchanged for two seconds, the candidate target node is then determined as the target node.

Through the above steps S1110 to S1130, in response to the swiping operation on the split control, the candidate target node can be determined from the plurality of quantity nodes; the duration of the swiping operation on the graphical user interface after the candidate target node is determined is obtained; and when the duration is greater than or equal to the value corresponding to the candidate target node, the candidate target node is determined as the target node.

In an embodiment of the present disclosure, in response to a duration of the second touch operation on the reload control being longer than a preset duration, the split control is displayed and the reload control is switched to a cancel control. The cancel control is configured to cancel a splitting process in response to a touch operation on the cancel control.

For example, in response to the second touch operation on the reload control being a long-press touch operation, when it is determined that the duration of the long-press touch operation is greater than the preset duration, such as 2 seconds, the split control is displayed and the reload control is switched to the cancel control. The split control can be displayed close to the cancel control.

For example, as shown in FIG. 6, the cancel control 601 is displayed in response to the duration of the second touch operation on the reload control being longer than the preset duration, and the split control 602 is generated and displayed at the same time, and in response to a touch operation on the cancel control 601 again, the splitting process can be cancelled.

In an embodiment of the present disclosure, a node schematic diagram may be displayed at a position corresponding to the candidate target node; and according to a value of the duration and the value corresponding to the candidate target node, the value of the duration is visually displayed in conjunction with the node schematic diagram. The method may include steps S1210 to S1220.

In the step S1210, the node schematic diagram is displayed at the position corresponding to the candidate target node.

In the step S1220, according to the value of the duration and the value corresponding to the candidate target node, the value of the duration is visually displayed in conjunction with the node schematic diagram.

In an embodiment of the present disclosure, the node schematic diagram may be displayed at the position corresponding to the candidate target node. For example, the node schematic diagram may be a circle or a ring.

Specifically, according to the value of the duration and the value corresponding to the candidate target node, the value of the duration may be visually displayed in conjunction with the node schematic diagram.

For example, a filling speed of the circle or a display speed of the ring may be calculated according to the value of the duration and the value corresponding to the candidate target node.

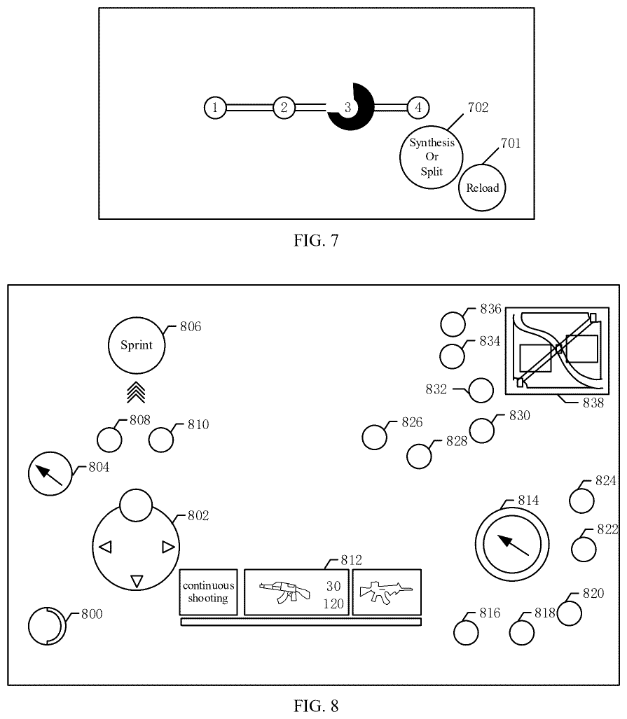

For example, as shown in FIG. 7, a control 702 may be the synthesis control or the split control, and there is a circular progress bar in the third quantity node (candidate target node), and the progress of the progress bar is calculated by the value of the duration and the value corresponding to the candidate target node. When the display progress of the circular progress bar reaches 100%, a completion symbol such as a check mark can be displayed at the position of the third quantity node. During the time progress process and after the progress is completed, the synthesis process or the splitting process can be canceled by the cancel control 701.

Through the above steps S1210 to S1220, the node schematic diagram may be displayed at the position corresponding to the candidate target node; and according to the value of the duration and the value corresponding to the candidate target node, the value of the duration is visually displayed in conjunction with the node schematic diagram. In embodiments of the present disclosure, the determined target node can be visually displayed through the time progress in the merging process and the splitting process, which can intuitively display the progress information and improve the interaction efficiency and the intuitiveness of information communication.

In an embodiment of the present disclosure, an attack power of the second ammunition items is associated with the second quantity. Specifically, the attack power of the second ammunition item may be in inverse proportion to the second quantity.

In an embodiment of the present disclosure, there is a splitting time corresponding to splitting the initial ammunition item into the second quantity of second ammunition items, and the second quantity is directly proportional to the splitting time. Specifically, the larger the value corresponding to the second quantity, the longer the splitting time required to split the initial ammunition item into the second ammunition item; and the smaller the value corresponding to the second quantity, the shorter the splitting time required to split the initial ammunition item into the second ammunition item.

The following provides an application scenario of the embodiment of the present disclosure. A schematic diagram of a graphical user interface is shown in FIG. 8. The graphical user interface includes a game scene and virtual objects located in the game scene, and the game scene and the virtual objects are not shown in FIG. 8. The player controls the virtual object to move in the game scene. The interface in FIG. 8 shows a variety of controls, and the controls are displayed on the game scene.

800 denotes a backpack control. The display of a backpack interface on the graphical user interface is trigged through a touch operation on the backpack control, which is configured to view items in the backpack. The items may include, but are not limited to, medicines, weapons, accessories, and protective gear. In an implementation, an edge line is provided on an edge of the backpack control to indicate the amount of items in the backpack. The touch operation on the backpack control may be click, double-click, long press, slide or other operations.

802 denotes a moving control, and a circle filled with shadow is a joystick in the moving control. In an implementation, the moving control is configured with a movement response area, and the movement response area may have the same size as the moving control, that is, an area in the graphical user interface corresponding to the moving control is the movement response area. In an implementation, the size of the movement response area may be larger than the size of the moving control, that is, the moving control is provided in the movement response area, and in terms of distance, the graphical user interface is divided into left and right areas from the middle, where the left area is the movement response area of the moving control. A movement control instruction is triggered by a touch operation on the movement response area of the moving control, and a moving direction of the virtual object is controlled according to the movement control instruction. The touch operation on the movement response area of the moving control can be click, double-click, long press, slide and other operations.

When it is detected that the touch operation that triggers the movement control instruction meets a preset condition, a “sprint” instruction is triggered to control the virtual object to automatically run continuously in the game scene. As shown in FIG. 8, in an implementation, the touch operation that triggers the movement control instruction meeting the preset condition is that a touch operation on a joystick area slides along a preset direction to a preset distance or a preset area (such as a position indicated by an arrow above the joystick). For example, when the touch operation is to drag the joystick upward, a sprint control 806 appears. When the sprint control is triggered, the virtual object enters a fast running mode. In addition, a control 830 is also a sprint control. When the control 830 is clicked, the virtual object enters the fast running mode. In an implementation, the touch operation that triggers the movement control instruction meeting the preset condition is that the touch operation on the joystick area meets a preset duration, or meets a preset pressure, etc.

804 and 814 are both attack controls. An attack instruction is triggered by a touch operation on an attack response area of the attack control, and the virtual character is controlled, according to the attack instruction, to perform an attack operation in the game scene. An attack behavior triggered by the attack control corresponds to the current equipped state of the virtual object. For example, when the virtual object is equipped with a long-range weapon, the attack behavior triggered by the attack control is the shooting behavior, that is, the left hand of the player can perform the shooting operation by triggering the control 804, and the right hand of the player can perform the shooting operation by triggering the control 814. When the virtual character is equipped with a melee weapon, the attack behavior triggered by the attack control is the slashing behavior. In an implementation, only one of the attack control 804 and the attack control 814 is displayed. A display position of the attack control can be adjusted according to a position setting instruction, and the position setting instruction can be triggered in a setting interface or in the process of the game. The touch operation on the attack control can be click, double-click, long press, slide and other operations.

808 and 810 are posture controls, and a posture adjustment instruction is triggered by a touch operation on the posture control, so as to adjust a posture of the virtual object in the game scene. Triggering the control 808 can control the weapon to be located at a left arm position of the virtual object, and control the virtual object to stand with its head turned to the left. Triggering the control 810 can control the weapon to be located at a right arm position of the virtual object, and control the virtual object to stand with its head turned to the right. 808 and 810 are mostly set to control the posture of the virtual object when the virtual object is hiding behind an obstacle such as the wall and the tree. The touch operation on the posture control can be click, double-click, long press, slide and other operations.

812 is a weapon slot. Triggering the weapon slot can switch a weapon used by the player. The “continuous shooting” on the left is set to indicate the current shooting mode. In the “continuous shooting” mode, multiple ammunitions are fired continuously. In addition to the “continuous shooting” mode, a “single shooting” mode can also be switched to. In the “single shooting” mode, the single ammunition is fired. The lower shadow bar is set to show the amount of ammunitions in the weapon. When shooting, the amount of ammunitions continues to decrease. When the amount of ammunitions becomes zero, the reload can be automatically performed. At this point, the amount of ammunitions is the minimum. In addition, a control 816 is a reload control. Triggering the reload control can add ammunitions to the currently used weapon. After the reload, the amount of ammunitions is the maximum. The touch operation on the weapon slot can be click, double-click, long press, slide and other operations.

Controls 818 and 820 are action controls, and the virtual object is controlled, through a touch operation on the action control, to perform corresponding actions in the game scene. For example, triggering 818 can control the virtual object to squat, and triggering 820 can control the virtual object to lie on the ground. The control 822 can control the virtual object to perform a jumping action. The touch operation on the action control can be click, double-click, long press, slide, and other operations.

A control 824 is set to control the current game scene to enter a scope-aiming mode. When a first touch operation on the control 824 is detected, the scope-aiming mode is controlled to be entered. In the scope-aiming mode, an aiming lens is displayed in the game scene, and a game scene seen by the virtual object through the aiming lens is also displayed. In the scope-aiming mode, the shooting accuracy can be improved. When a second touch operation on the control 824 is detected, the scope-aiming mode is controlled to be exited. In an implementation, the first touch operation and the second touch operation are independent touch operations. For example, the control 824 is clicked to control the current game scene to enter the scope-aiming mode, and the control 824 is clicked again to exit the scope-aiming mode, and display the game scene shot by a virtual camera following the virtual object again. In an implementation, the first touch operation and the second touch operation can be a starting operation and an ending operation of a touch operation. For example, when the touch of the control 824 is detected, the game scene is controlled to enter the scope-aiming mode. During the continuous pressing process, the game scene is controlled to continue to be in the scope-aiming mode. When it is detected that the touch that triggers the touch operation ends and leaves the touch detection area, the scope-aiming mode is controlled to be exited.

A control 826 is set to control a shooting parameter of the virtual camera presenting the game screen, thereby adjusting the field of view of the game scene displayed in the graphical user interface. In an implementation, it is determined that a touch operation on the control 826 is detected, and the shooting parameter of the virtual camera is adjusted according to the touch operation. The shooting parameter includes but is not limited to the position, orientation, and viewing angle of the virtual camera. The touch operation on the control 826 may be click, double-click, long press, slide, or other operations.

A control 828 is a marking control, and the virtual object, the virtual item, etc. in the game scene are marked through the touch operation on the marking control. A control 832 is a setting control. The control 832 is clicked to display a setting menu. The setting is to set basic functions of the current game. The touch operation on the control 828 can be click, double-click, long press, slide, or other operations.

Controls 834 and 836 are message controls, where 834 can be configured to view system notifications, and 836 can be configured to view messages sent by teammates, or send messages to teammates. 838 is a small map, which is configured to display the position of the virtual object controlled by the player, and can also display positions of virtual objects of some other players.

Based on the above application scenario, the number of initial ammunition items of the virtual firearm can be obtained; when the number of initial ammunition items is greater than the first preset value, in response to the first touch operation on the reload control, the first quantity of initial ammunition items is merged into the first ammunition item; and in response to the use operation on the first ammunition item, the virtual firearm is controlled to interact, through the first ammunition item, with the virtual object in the virtual scene, so as to execute the method for interacting with the virtual firearm of the present disclosure.

Based on the above application scenario, the player can trigger, through the reload control 816, the execution of the method for interacting with the virtual firearm in the embodiment of the present disclosure.

In the technical solutions provided by some embodiments of the present disclosure, the number of initial ammunition items of the virtual firearm can be obtained; when the number of initial ammunition items is greater than the first preset value, in response to the first touch operation on the reload control, the first quantity of initial ammunition items is merged into the first ammunition item; and in response to the use operation on the first ammunition item, the virtual firearm is controlled to interact, through the first ammunition item, with the virtual object in the virtual scene. In embodiments of the present disclosure, on the one hand, when the number of ammunition items is greater than the first preset value, the ammunition items can be merged to enhance a preset shooting property of the virtual firearm, thereby achieving a better interaction effect without a large number of interactive operations, and improving the interaction efficiency; on the other hand, the user can define an interaction mode of the virtual firearm, avoiding the interaction in a single fixed mode, thereby improving the flexibility and freedom of the interaction process.

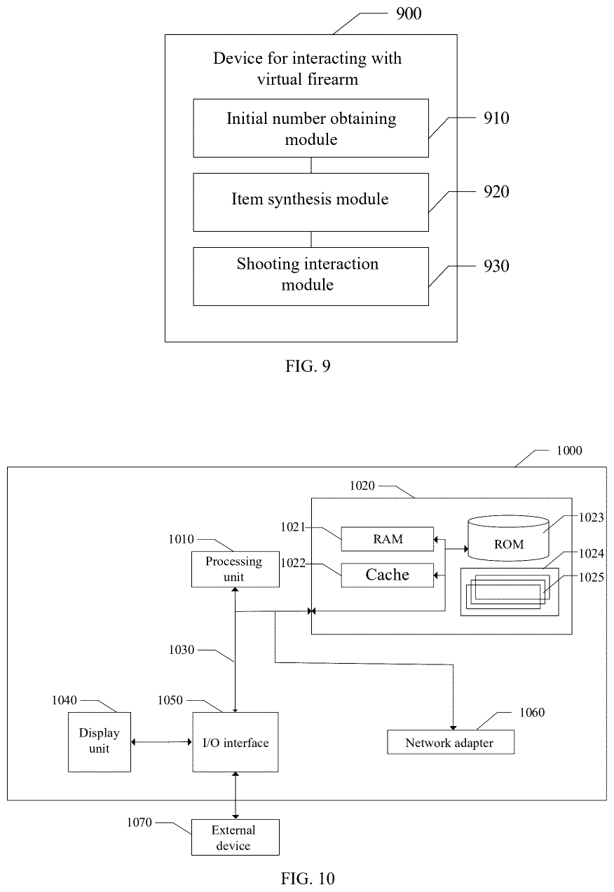

Furthermore, in an example implementation, a device 900 for interacting with a virtual firearm is further provided. A graphical user interface is provided by a terminal device, the graphical user interface at least partially displays a virtual scene and a reload control, and the virtual scene includes a virtual object. Referring to FIG. 9, the device 900 for interacting with the virtual firearm may include:
an initial number obtaining module 910, configured to obtain the number of initial ammunition items of the virtual firearm;
an item synthesis module 920, configured to, when the number of initial ammunition items is greater than a first preset value, in response to a first touch operation on the reload control, merge a first quantity of initial ammunition items into a first ammunition item, wherein the first quantity is less than or equal to the number of initial ammunition items, and an attack power of the first ammunition item is higher than an attack power of an initial ammunition item; and
a shooting interaction module 930, configured to, in response to a use operation on the first ammunition item, control the virtual firearm to interact, through the first ammunition item, with the virtual object in the virtual scene.

In an embodiment of the present disclosure, the device further includes: a second preset value comparison unit, configured to, when the number of initial ammunition items is less than a second preset value, in response to a second touch operation on the reload control, split the initial ammunition item into a second quantity of second ammunition items, wherein the second quantity is less than or equal to a maximum ammunition item capacity of the virtual firearm, and an attack power of a second ammunition item is lower than the attack power of the initial ammunition item; and a second use operation response unit, configured to, in response to a use operation on the second ammunition item, control the virtual firearm to interact, through the second ammunition item, with the virtual object in the virtual scene.

In an embodiment of the present disclosure, for the step of when the number of initial ammunition items is greater than the first preset value, in response to the first touch operation on the reload control, merging the first quantity of initial ammunition items into the first ammunition item, the device further includes: a first preset value comparison unit, configured to, when the number of initial ammunition items is greater than the first preset value, in response to the first touch operation on the reload control, display a first quantity selection control on the graphical user interface, wherein the first quantity selection control includes a plurality of quantity nodes; a first user operation response unit, configured to, in response to a user operation, determine a target node from the plurality of quantity nodes; and a first quantity reference unit, configured to merge, according to the first quantity corresponding to the target node, the first quantity of initial ammunition items into the first ammunition item.

In an embodiment of the present disclosure, for the step of in response to the first touch operation on the reload control, displaying the first quantity selection control on the graphical user interface, the device further includes: a synthesis control display unit, configured to, in response to the first touch operation on the reload control, display a synthesis control; and a synthetic touch response unit, configured to, in response to a touch operation on the synthesis control, display the first quantity selection control on the graphical user interface.

In an embodiment of the present disclosure, for the step of in response to the user operation, determining the target node from the plurality of quantity nodes, the device further includes: a first swiping operation response unit, configured to, in response to a swiping operation on the synthesis control, determine the target node from the plurality of quantity nodes.

In an embodiment of the present disclosure, for the step of displaying the first quantity selection control on the graphical user interface, the device further includes: a loading quantity reference unit, configured to, according to a maximum ammunition item capacity of the virtual firearm, display, in the first quantity selection control, the plurality of quantity nodes corresponding to the maximum ammunition item capacity, wherein the plurality of quantity nodes include the same number of adjustable nodes as the initial ammunition items, and the adjustable nodes correspond to an adjustable area; and a highlighting unit, configured to highlight the adjustable area in a preset manner.

In an embodiment of the present disclosure, for the step of in response to the swiping operation on the synthesis control, determining the target node from the plurality of quantity nodes, the device further includes: a first candidate target node determination unit, configured to, in response to the swiping operation on the synthesis control, determine a candidate target node from the plurality of quantity nodes, wherein the plurality of quantity nodes include the candidate target node; and a first duration obtaining unit, configured to obtain a duration, after the candidate target node is determined, of the swiping operation on the graphical user interface; and a first duration comparison unit, configured to, when the duration is greater than or equal to a value corresponding to the candidate target node, determine the candidate target node as the target node.

In an embodiment of the present disclosure, for the step of in response to the first touch operation on the reload control, displaying the synthesis control, the device further includes: a first duration comparison unit, configured to, in response to a duration of the first touch operation on the reload control being longer than a preset duration, display the synthesis control and switch the reload control to a cancel control; wherein the cancel control is configured to cancel a merging process in response to a touch operation on the cancel control.

In an embodiment of the present disclosure, in response to the first touch operation on the reload control, merging the first quantity of initial ammunition items into the first ammunition item, the device further includes: a maximum loading quantity synthesis unit, configured to, when the number of initial ammunition items of the virtual firearm is equal to a maximum ammunition item capacity of the virtual firearm, merge the initial ammunition items of the virtual firearm into the first ammunition item; wherein the number of initial ammunition items of the virtual firearm is the first quantity.

In an embodiment of the present disclosure, the attack power of the first ammunition item is associated with the first quantity.

In an embodiment of the present disclosure, in response to the first touch operation on the reload control, merging the first quantity of initial ammunition items into the first ammunition item, the device further includes: a preset merging unit, configured to, in response to the first touch operation on the reload control, merge the first quantity of initial ammunition items into a plurality of first ammunition items according to a preset merging manner; wherein the preset merging manner is configured to indicate the number of initial ammunition items required for merging into one first ammunition item.

In an embodiment of the present disclosure, in response to the first touch operation on the reload control, merging the first quantity of initial ammunition items into the first ammunition item, the device includes: a first candidate ammunition item merging unit, configured to, in response to the first touch operation on the reload control, merge the first quantity of initial ammunition items into a plurality of first candidate ammunition items; and a first ammunition item re-synthesis unit, configured to, in response to a third touch operation on the reload control, merge the plurality of first candidate ammunition items into the first ammunition item.

In an embodiment of the present disclosure, merging the first quantity of initial ammunition items into the first ammunition item corresponds to a synthesis time, and the first quantity is directly proportional to the synthesis time.

In an embodiment of the present disclosure, for the step of when the number of initial ammunition items is less than the second preset value, in response to the second touch operation on the reload control, splitting the initial ammunition item into the second quantity of second ammunition items, the device further includes: a second preset value comparison unit, configured to, when the number of initial ammunition items is less than the second preset value, in response to the second touch operation on the reload control, display a second quantity selection control on the graphical user interface, wherein the second quantity selection control includes a plurality of quantity nodes; a user operation response unit, configured to, in response to a user operation, determine a target node from the plurality of quantity nodes; and an initial ammunition item splitting unit, configured to split, according to the second quantity corresponding to the target node, the initial ammunition item into the second quantity of second ammunition items.

In an embodiment of the present disclosure, for the step of in response to the second touch operation on the reload control, displaying the second quantity selection control on the graphical user interface, the device further includes: a split control display unit, configured to, in response to the second touch operation on the reload control, display a split control; and a split control touch unit, configured to, in response to a touch operation on the split control, display the second quantity selection control on the graphical user interface.

In an embodiment of the present disclosure, for the step of in response to the user operation, determining the target node from the plurality of quantity nodes, the device further includes: a second swiping operation response unit, configured to, in response to a swiping operation on the split control, determine the target node from the plurality of quantity nodes.

In an embodiment of the present disclosure, for the step of in response to the swiping operation on the split control, determining the target node from the plurality of quantity nodes, the device further includes: a second candidate target node determination unit, configured to, in response to the swiping operation on the split control, determine a candidate target node from the plurality of quantity nodes; a second duration obtaining unit, configured to obtain a duration, after the candidate target node is determined, of the swiping operation on the graphical user interface; and a second duration comparison unit, configured to, when the duration is greater than or equal to a value corresponding to the candidate target node, determine the candidate target node as the target node.

In an embodiment of the present disclosure, for the step of in response to the second touch operation on the reload control, displaying the split control, the device further includes: a second duration comparison unit, configured to, in response to a duration of the second touch operation on the reload control being longer than a preset duration, display the split control and switch the reload control to a cancel control; wherein the cancel control is configured to cancel a splitting process in response to a touch operation on the cancel control.

In an embodiment of the present disclosure, the device further includes: a node schematic diagram display unit, configured to display a node schematic diagram at a position corresponding to the candidate target node; and a visualization display unit, configured to, according to a value of the duration and the value corresponding to the candidate target node, visually display the value of the duration in conjunction with the node schematic diagram.

In an embodiment of the present disclosure, the attack power of the second ammunition item is associated with the second quantity.

In an embodiment of the present disclosure, splitting the initial ammunition item into the second quantity of second ammunition items corresponds to a splitting time, and the second quantity is directly proportional to the splitting time.

It should be noted that although several modules or units of the devices configured to perform actions are mentioned in the above detailed description, such division of modules or units is not mandatory. In fact, features and functions of two or more of the modules or units described above may be embodied in one module or unit in accordance with embodiments of the present disclosure. Conversely, the features and functions of one module or unit described above may be further divided to be embodied by multiple modules or units.

In addition, in an embodiment of the present disclosure, there is further provided an electronic device capable of implementing the method for interacting with the virtual firearm as mentioned above.

Those skilled in the art can understand that various aspects of the present disclosure may be implemented as a system, a method, or a program product. Therefore, various aspects of the present disclosure can be embodied in the following forms: a complete hardware implementation, a complete software implementation (including firmware, microcode, etc.), or a combination of hardware and software implementations, which can be collectively referred to as “circuit”, “module’, or “system”.

An electronic device 1000 of such embodiment of the present disclosure is described below with reference to FIG. 10. The electronic device 1000 shown in FIG. 10 is only an example and should not bring any limitations to the functions and scope of use of embodiments of the present disclosure.

As shown in FIG. 10, the electronic device 1000 takes the form of a general-purpose computing device. Components of the electronic device 1000 may include, but are not limited to: at least one processing unit 1010, at least one storage unit 1020, a bus 1030 connecting different system components (including the storage unit 1020 and the processing unit 1010) and a display unit 1040.

The storage unit stores program codes which can be executed by the processing unit 1010 to cause the processing unit 1010 to perform the steps according to various embodiments of the present disclosure described in the “example methods” section of the present specification. For example, the processing unit 1010 may perform, as shown in FIG. 2, the step S210 of obtaining the number of initial ammunition items of the virtual firearm, the step S220 of when the number of initial ammunition items is greater than a first preset value, in response to a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and the step S230 of in response to a use operation on the first ammunition item, controlling the virtual firearm to interact, through the first ammunition item, with the virtual object in the virtual scene.

In an embodiment of the present disclosure, based on the aforementioned scheme, when the number of initial ammunition items is less than a second preset value, in response to a second touch operation on the reload control, the initial ammunition item is split into a second quantity of second ammunition items, wherein the second quantity is less than or equal to a maximum ammunition item capacity of the virtual firearm, and an attack power of a second ammunition item is lower than the attack power of the initial ammunition item; and in response to a use operation on the second ammunition item, the virtual firearm is controlled to interact, through the second ammunition item, with the virtual object in the virtual scene.

In an embodiment of the present disclosure, based on the aforementioned scheme, when the number of initial ammunition items is greater than the first preset value, in response to the first touch operation on the reload control, merging the first quantity of initial ammunition items into the first ammunition item includes: when the number of initial ammunition items is greater than the first preset value, in response to the first touch operation on the reload control, displaying a first quantity selection control on the graphical user interface, wherein the first quantity selection control includes a plurality of quantity nodes; in response to a user operation, determining a target node from the plurality of quantity nodes; and merging, according to the first quantity corresponding to the target node, the first quantity of initial ammunition items into the first ammunition item.

In an embodiment of the present disclosure, based on the aforementioned scheme, in response to the first touch operation on the reload control, displaying the first quantity selection control on the graphical user interface includes: in response to the first touch operation on the reload control, displaying a synthesis control; and in response to a touch operation on the synthesis control, displaying the first quantity selection control on the graphical user interface.

In an embodiment of the present disclosure, based on the aforementioned scheme, in response to the user operation, determining the target node from the plurality of quantity nodes includes: in response to a swiping operation on the synthesis control, determining the target node from the plurality of quantity nodes.

In an embodiment of the present disclosure, based on the aforementioned scheme, displaying the first quantity selection control on the graphical user interface includes: according to a maximum ammunition item capacity of the virtual firearm, displaying, in the first quantity selection control, the plurality of quantity nodes corresponding to the maximum ammunition item capacity, wherein the plurality of quantity nodes include the same number of adjustable nodes as the initial ammunition items, and the adjustable nodes correspond to an adjustable area; and highlighting the adjustable area in a preset manner.

In an embodiment of the present disclosure, based on the aforementioned scheme, in response to the swiping operation on the synthesis control, determining the target node from the plurality of quantity nodes includes: in response to the swiping operation on the synthesis control, determining a candidate target node from the plurality of quantity nodes, wherein the plurality of quantity nodes include the candidate target node; obtaining a duration, after the candidate target node is determined, of the swiping operation on the graphical user interface; and when the duration is greater than or equal to a value corresponding to the candidate target node, determining the candidate target node as the target node.

In an embodiment of the present disclosure, based on the aforementioned scheme, in response to the first touch operation on the reload control, displaying the synthesis control includes: in response to a duration of the first touch operation on the reload control being longer than a preset duration, displaying the synthesis control and switching the reload control to a cancel control; wherein the cancel control is configured to cancel a merging process in response to a touch operation on the cancel control.

In an embodiment of the present disclosure, based on the aforementioned scheme, in response to the first touch operation on the reload control, merging the first quantity of initial ammunition items into the first ammunition item includes: when the number of initial ammunition items of the virtual firearm is equal to a maximum ammunition item capacity of the virtual firearm, merging the initial ammunition items of the virtual firearm into the first ammunition item; wherein the number of initial ammunition items of the virtual firearm is the first quantity.

In an embodiment of the present disclosure, based on the aforementioned solution, the attack power of the first ammunition item is associated with the first quantity.

In an embodiment of the present disclosure, based on the aforementioned scheme, in response to the first touch operation on the reload control, merging the first quantity of initial ammunition items into the first ammunition item includes: in response to the first touch operation on the reload control, merging the first quantity of initial ammunition items into a plurality of first ammunition items according to a preset merging manner; wherein the preset merging manner is configured to indicate the number of initial ammunition items required for merging into one first ammunition item.

In an embodiment of the present disclosure, based on the aforementioned scheme, in response to the first touch operation on the reload control, merging the first quantity of initial ammunition items into the first ammunition item includes: in response to the first touch operation on the reload control, merging the first quantity of initial ammunition items into a plurality of first candidate ammunition items; and in response to a third touch operation on the reload control, merging the plurality of first candidate ammunition items into the first ammunition item.

In an embodiment of the present disclosure, based on the above-mentioned solution, merging the first quantity of initial ammunition items into the first ammunition item corresponds to a synthesis time, and the first quantity is directly proportional to the synthesis time.

In an embodiment of the present disclosure, based on the aforementioned scheme, when the number of initial ammunition items is less than the second preset value, in response to the second touch operation on the reload control, splitting the initial ammunition item into the second quantity of second ammunition items includes: when the number of initial ammunition items is less than the second preset value, in response to the second touch operation on the reload control, displaying a second quantity selection control on the graphical user interface, wherein the second quantity selection control includes a plurality of quantity nodes; in response to a user operation, determining a target node from the plurality of quantity nodes; and splitting, according to the second quantity corresponding to the target node, the initial ammunition item into the second quantity of second ammunition items.

In an embodiment of the present disclosure, based on the aforementioned scheme, in response to the second touch operation on the reload control, displaying the second quantity selection control on the graphical user interface includes: in response to the second touch operation on the reload control, displaying a split control; and in response to a touch operation on the split control, displaying the second quantity selection control on the graphical user interface.

In an embodiment of the present disclosure, based on the aforementioned scheme, in response to the user operation, determining the target node from the plurality of quantity nodes includes: in response to a swiping operation on the split control, determining the target node from the plurality of quantity nodes.

In an embodiment of the present disclosure, based on the aforementioned scheme, in response to the swiping operation on the split control, determining the target node from the plurality of quantity nodes includes: in response to the swiping operation on the split control, determining a candidate target node from the plurality of quantity nodes; obtaining a duration, after the candidate target node is determined, of the swiping operation on the graphical user interface; and when the duration is greater than or equal to a value corresponding to the candidate target node, determining the candidate target node as the target node.

In an embodiment of the present disclosure, based on the aforementioned scheme, in response to the second touch operation on the reload control, displaying the split control includes: in response to a duration of the second touch operation on the reload control being longer than a preset duration, displaying the split control and switching the reload control to a cancel control; and wherein the cancel control is configured to cancel a splitting process in response to a touch operation on the cancel control.

In an embodiment of the present disclosure, based on the aforementioned scheme, a node schematic diagram is displayed at a position corresponding to the candidate target node; and according to a value of the duration and the value corresponding to the candidate target node, the value of the duration is visually displayed in conjunction with the node schematic diagram.

In an embodiment of the present disclosure, based on the aforementioned solution, the attack power of the second ammunition item is associated with the second quantity.

In an embodiment of the present disclosure, based on the above-mentioned solution, splitting the initial ammunition item into the second quantity of second ammunition items corresponds to a splitting time, and the second quantity is directly proportional to the splitting time.

The electronic device provided by some embodiments of the present disclosure can obtain the number of initial ammunition items of the virtual firearm; when the number of initial ammunition items is greater than a first preset value, in response to a first touch operation on the reload control, merge a first quantity of initial ammunition items into a first ammunition item; and in response to a use operation on the first ammunition item, control the virtual firearm to interact, through the first ammunition item, with the virtual object in the virtual scene. In embodiments of the present disclosure, on the one hand, when the number of ammunition items is greater than the first preset value, the ammunition items can be merged to enhance a preset shooting property of the virtual firearm, thereby achieving a better interaction effect without a large number of interactive operations, and improving the interaction efficiency; on the other hand, the user can define an interaction mode of the virtual firearm, avoiding the interaction in a single fixed mode, thereby improving the flexibility and freedom of the interaction process.

The storage unit 1020 may include a readable medium in the form of a volatile storage unit, such as a random access storage unit (RAM) 1021 and/or a cache storage unit 1022, and may further include a read-only storage unit (ROM) 1023.

The storage unit 1020 may further include a program/utility tool 1024 having a set (at least one) of program modules 1025. Such program modules 1025 include, but are not limited to, an operating system, one or more application programs, other program modules, and program data. Each or some combination of these examples may include an implementation of a network environment.

The bus 1030 may be one or more of several types of bus structures, including a memory unit bus or a memory unit controller, a peripheral bus, a graphics acceleration port, a processing unit, or a local area bus using any bus structure in a variety of bus structures.

The electronic device 1000 may also communicate with one or more external devices 1070 (such as a keyboard, a pointing device, a Bluetooth device, etc.), and may also communicate with one or more devices that enable a user to interact with the electronic device 1000, and/or may also communicate with any device (such as a router, a modem) that can enable the electronic device 1000 to interact with one or more other computing devices. Such communication may be performed through an input/output (I/O) interface 1050. Moreover, the electronic device 1000 may also communicate with one or more networks (such as a local area network (LAN), a wide area network (WAN), and/or a public network, such as the Internet) through the network adapter 1060. As shown in the figure, the network adapter 1060 communicates with other modules of the electronic device 1000 through the bus 1030. It should be understood that although not shown in the figure, other hardware and/or software modules may be used in conjunction with the electronic device 1000, including but not limited to: microcode, device drivers, redundant processing units, external disk drive arrays, RAID systems, tape drives and data backup storage systems.

Through the description of the foregoing embodiments, those skilled in the art can easily understand that the example embodiments described herein may be implemented by software, or by software in combination with necessary hardware. Therefore, the technical solutions according to the embodiments of the present disclosure may be embodied in the form of a software product, and the software product may be stored in a non-volatile storage medium (which may be a CD-ROM, a U disk, a mobile hard disk, etc.) or on a network. The software product may include instructions to cause a computing device (which may be a personal computer, a server, a terminal device, or a network device, etc.) to execute the method according to embodiments of the present disclosure.

In an embodiment of the present disclosure, there is further provided a computer-readable storage medium having a program product stored thereon which capable of implementing the method described above in this specification. In some embodiments of the present disclosure, various aspects of the present disclosure may also be implemented in the form of a program product, which includes program codes. When the program product is run on a terminal device, the program code is used to cause the terminal device to perform steps according to various embodiments of the present disclosure described in the above-mentioned “Example Method” section of this specification.

In an embodiment of the present disclosure, a graphical user interface is provided by a terminal device, the graphical user interface at least partially displays a virtual scene and a reload control, and the virtual scene includes a virtual object, and the method includes: obtaining the number of initial ammunition items of the virtual firearm; when the number of initial ammunition items is greater than a first preset value, in response to a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and in response to a use operation on the first ammunition item, controlling the virtual firearm to interact, through the first ammunition item, with the virtual object in the virtual scene.

In an embodiment of the present disclosure, based on the aforementioned scheme, when the number of initial ammunition items is less than a second preset value, in response to a second touch operation on the reload control, the initial ammunition item is split into a second quantity of second ammunition items, wherein the second quantity is less than or equal to a maximum ammunition item capacity of the virtual firearm, and an attack power of a second ammunition item is lower than the attack power of the initial ammunition item; and in response to a use operation on the second ammunition item, the virtual firearm is controlled to interact, through the second ammunition item, with the virtual object in the virtual scene.

In an embodiment of the present disclosure, based on the aforementioned scheme, when the number of initial ammunition items is greater than the first preset value, in response to the first touch operation on the reload control, merging the first quantity of initial ammunition items into the first ammunition item includes: when the number of initial ammunition items is greater than the first preset value, in response to the first touch operation on the reload control, displaying a first quantity selection control on the graphical user interface, wherein the first quantity selection control includes a plurality of quantity nodes; in response to a user operation, determining a target node from the plurality of quantity nodes; and merging, according to the first quantity corresponding to the target node, the first quantity of initial ammunition items into the first ammunition item.

In an embodiment of the present disclosure, based on the aforementioned scheme, in response to the first touch operation on the reload control, displaying the first quantity selection control on the graphical user interface includes: in response to the first touch operation on the reload control, displaying a synthesis control; and in response to a touch operation on the synthesis control, displaying the first quantity selection control on the graphical user interface.

In an embodiment of the present disclosure, based on the aforementioned scheme, in response to the user operation, determining the target node from the plurality of quantity nodes includes: in response to a swiping operation on the synthesis control, determining the target node from the plurality of quantity nodes.

In an embodiment of the present disclosure, based on the aforementioned scheme, displaying the first quantity selection control on the graphical user interface includes: according to a maximum ammunition item capacity of the virtual firearm, displaying, in the first quantity selection control, the plurality of quantity nodes corresponding to the maximum ammunition item capacity, wherein the plurality of quantity nodes include the same number of adjustable nodes as the initial ammunition items, and the adjustable nodes correspond to an adjustable area; and highlighting the adjustable area in a preset manner.

In an embodiment of the present disclosure, based on the aforementioned scheme, in response to the swiping operation on the synthesis control, determining the target node from the plurality of quantity nodes includes: in response to the swiping operation on the synthesis control, determining a candidate target node from the plurality of quantity nodes, wherein the plurality of quantity nodes include the candidate target node; obtaining a duration, after the candidate target node is determined, of the swiping operation on the graphical user interface; and when the duration is greater than or equal to a value corresponding to the candidate target node, determining the candidate target node as the target node.

In an embodiment of the present disclosure, based on the aforementioned scheme, in response to the first touch operation on the reload control, displaying the synthesis control includes: in response to a duration of the first touch operation on the reload control being longer than a preset duration, displaying the synthesis control and switching the reload control to a cancel control; wherein the cancel control is configured to cancel a merging process in response to a touch operation on the cancel control.

In an embodiment of the present disclosure, based on the aforementioned scheme, in response to the first touch operation on the reload control, merging the first quantity of initial ammunition items into the first ammunition item includes: when the number of initial ammunition items of the virtual firearm is equal to a maximum ammunition item capacity of the virtual firearm, merging the initial ammunition items of the virtual firearm into the first ammunition item; wherein the number of initial ammunition items of the virtual firearm is the first quantity.

In an embodiment of the present disclosure, based on the aforementioned solution, the attack power of the first ammunition item is associated with the first quantity.

In an embodiment of the present disclosure, based on the aforementioned scheme, in response to the first touch operation on the reload control, merging the first quantity of initial ammunition items into the first ammunition item includes: in response to the first touch operation on the reload control, merging the first quantity of initial ammunition items into a plurality of first ammunition items according to a preset merging manner; wherein the preset merging manner is configured to indicate the number of initial ammunition items required for merging into one first ammunition item.

In an embodiment of the present disclosure, based on the aforementioned scheme, in response to the first touch operation on the reload control, merging the first quantity of initial ammunition items into the first ammunition item includes: in response to the first touch operation on the reload control, merging the first quantity of initial ammunition items into a plurality of first candidate ammunition items; and in response to a third touch operation on the reload control, merging the plurality of first candidate ammunition items into the first ammunition item.

In an embodiment of the present disclosure, based on the above-mentioned solution, merging the first quantity of initial ammunition items into the first ammunition item corresponds to a synthesis time, and the first quantity is directly proportional to the synthesis time.

In an embodiment of the present disclosure, based on the aforementioned scheme, when the number of initial ammunition items is less than the second preset value, in response to the second touch operation on the reload control, splitting the initial ammunition item into the second quantity of second ammunition items includes: when the number of initial ammunition items is less than the second preset value, in response to the second touch operation on the reload control, displaying a second quantity selection control on the graphical user interface, wherein the second quantity selection control includes a plurality of quantity nodes; in response to a user operation, determining a target node from the plurality of quantity nodes; and splitting, according to the second quantity corresponding to the target node, the initial ammunition item into the second quantity of second ammunition items.

In an embodiment of the present disclosure, based on the aforementioned scheme, in response to the second touch operation on the reload control, displaying the second quantity selection control on the graphical user interface includes: in response to the second touch operation on the reload control, displaying a split control; and in response to a touch operation on the split control, displaying the second quantity selection control on the graphical user interface.

In an embodiment of the present disclosure, based on the aforementioned scheme, in response to the user operation, determining the target node from the plurality of quantity nodes includes: in response to a swiping operation on the split control, determining the target node from the plurality of quantity nodes.

In an embodiment of the present disclosure, based on the aforementioned scheme, in response to the swiping operation on the split control, determining the target node from the plurality of quantity nodes includes: in response to the swiping operation on the split control, determining a candidate target node from the plurality of quantity nodes; obtaining a duration, after the candidate target node is determined, of the swiping operation on the graphical user interface; and when the duration is greater than or equal to a value corresponding to the candidate target node, determining the candidate target node as the target node.

In an embodiment of the present disclosure, based on the aforementioned scheme, in response to the second touch operation on the reload control, displaying the split control includes: in response to a duration of the second touch operation on the reload control being longer than a preset duration, displaying the split control and switching the reload control to a cancel control; and wherein the cancel control is configured to cancel a splitting process in response to a touch operation on the cancel control.

In an embodiment of the present disclosure, based on the aforementioned scheme, a node schematic diagram is displayed at a position corresponding to the candidate target node; and according to a value of the duration and the value corresponding to the candidate target node, the value of the duration is visually displayed in conjunction with the node schematic diagram.

In an embodiment of the present disclosure, based on the aforementioned solution, the attack power of the second ammunition item is associated with the second quantity.

In an embodiment of the present disclosure, based on the above-mentioned solution, splitting the initial ammunition item into the second quantity of second ammunition items corresponds to a splitting time, and the second quantity is directly proportional to the splitting time.

The computer-readable signal medium provided in some embodiments of the present disclosure can obtain the number of initial ammunition items of the virtual firearm; when the number of initial ammunition items is greater than a first preset value, in response to a first touch operation on the reload control, merge a first quantity of initial ammunition items into a first ammunition item; and in response to a use operation on the first ammunition item, control the virtual firearm to interact, through the first ammunition item, with the virtual object in the virtual scene. In embodiments of the present disclosure, on the one hand, when the number of ammunition items is greater than the first preset value, the ammunition items can be merged to enhance a preset shooting property of the virtual firearm, thereby achieving a better interaction effect without a large number of interactive operations, and improving the interaction efficiency; on the other hand, the user can define an interaction mode of the virtual firearm, avoiding the interaction in a single fixed mode, thereby improving the flexibility and freedom of the interaction process.

The computer-readable signal medium may include a data signal in baseband or propagated as part of a carrier wave, which carries readable program codes. Such an propagated data signal may have many forms, including but not limited to electromagnetic signals, optical signals, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure may be written in any combination of one or more programming languages, which include object-oriented programming languages, such as Java, C++, and so on. The programming languages also include conventional procedural programming language, such as “C” or a similar programming language. The program codes may be executed entirely on the user computing device, may be executed partly on the user device, may be executed as an independent software package, may be executed partly on the user computing device and partly on a remote computing device, or may be executed entirely on the remote computing device or server. In the case of a remote computing device, the remote computing device may be connected to the user computing device through any kind of network, including a local area network (LAN) or a wide area network (WAN), or the remote computing device may be connected to an external computing device, for example, by the Internet provided by the Internet service providers.

In addition, the above drawings are merely schematic descriptions of processes included in the methods according to embodiments of the present disclosure, and are not for limiting the present disclosure. It is easy to understand that the processes shown in the drawings do not indicate or limit the chronological order of these processes. In addition, it is also easy to understand that these processes may be performed synchronously or asynchronously in a plurality of modules, for example

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

1. A method for interacting with a virtual firearm, comprising:
obtaining the number of initial ammunition items of the virtual firearm, wherein a graphical user interface is provided by a terminal device, the graphical user interface displays a virtual scene and a reload control, and the virtual scene comprises a virtual object;
in response to determining that the number of initial ammunition items is greater than a first preset value, and in response to detecting a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and
in response to detecting a use operation on the first ammunition item, controlling the virtual firearm to interact, through the first ammunition item, with the virtual object in the virtual scene.

2. The method according to claim 1, wherein the method further comprises:
in response to determining that the number of initial ammunition items is less than a second preset value, and in response to detecting a second touch operation on the reload control, splitting the initial ammunition item into a second quantity of second ammunition items, wherein the second quantity is less than or equal to a maximum ammunition item capacity of the virtual firearm, and an attack power of a second ammunition item is lower than the attack power of the initial ammunition item; and
in response to detecting a use operation on the second ammunition item, controlling the virtual firearm to interact, through the second ammunition item, with the virtual object in the virtual scene.

3. The method according to claim 1, wherein in response to determining that the number of initial ammunition items is greater than the first preset value, and in response to detecting the first touch operation on the reload control, merging the first quantity of initial ammunition items into the first ammunition item comprises:
in response to determining that the number of initial ammunition items is greater than the first preset value, and in response to detecting the first touch operation on the reload control, displaying a first quantity selection control on the graphical user interface, wherein the first quantity selection control comprises a plurality of quantity nodes;
in response to detecting a user operation, determining a target quantity node from the plurality of quantity nodes; and
merging, according to the first quantity corresponding to the target quantity node, the first quantity of initial ammunition items into the first ammunition item.

4. The method according to claim 3, wherein in response to detecting the first touch operation on the reload control, displaying the first quantity selection control on the graphical user interface comprises:
in response to detecting the first touch operation on the reload control, displaying a synthesis control; and
in response to detecting a touch operation on the synthesis control, displaying the first quantity selection control on the graphical user interface.

5. The method according to claim 4, wherein in response to detecting the user operation, determining the target quantity node from the plurality of quantity nodes comprises:
in response to detecting a swiping operation on the synthesis control, determining the target quantity node from the plurality of quantity nodes.

6. The method according to claim 3, wherein displaying the first quantity selection control on the graphical user interface comprises:
according to a maximum ammunition item capacity of the virtual firearm, displaying, in the first quantity selection control, the plurality of quantity nodes corresponding to the maximum ammunition item capacity, wherein the plurality of quantity nodes comprise the same number of adjustable nodes as the initial ammunition items, and the adjustable nodes correspond to an adjustable area; and
highlighting the adjustable area in a preset manner.

7. The method according to claim 5, wherein in response to detecting the swiping operation on the synthesis control, determining the target quantity node from the plurality of quantity nodes comprises:
in response to detecting the swiping operation on the synthesis control, determining a candidate target quantity node from the plurality of quantity nodes, wherein the plurality of quantity nodes comprise the candidate target quantity node;
obtaining a duration, after the candidate target quantity node is determined, of the swiping operation on the graphical user interface; and
in response to determining that the duration is greater than or equal to a value corresponding to the candidate target quantity node, determining the candidate target quantity node as the target quantity node.

8. The method according to claim 4, wherein in response to detecting the first touch operation on the reload control, displaying the synthesis control comprises:
in response to determining that a duration of the first touch operation on the reload control is longer than a preset duration, displaying the synthesis control and switching the reload control to a cancel control;
wherein the cancel control is configured to cancel a merging process in response to detecting a touch operation on the cancel control.

9. The method according to claim 1, wherein in response to detecting the first touch operation on the reload control, merging the first quantity of initial ammunition items into the first ammunition item comprises:
in response to determining that the number of initial ammunition items of the virtual firearm is equal to a maximum ammunition item capacity of the virtual firearm, merging the initial ammunition items of the virtual firearm into the first ammunition item;
wherein the number of initial ammunition items of the virtual firearm is the first quantity.

10. The method according to claim 1, wherein the attack power of the first ammunition item is associated with the first quantity; and
wherein in response to detecting the first touch operation on the reload control, merging the first quantity of initial ammunition items into the first ammunition item comprises:
in response to detecting the first touch operation on the reload control, merging the first quantity of initial ammunition items into a plurality of first ammunition items according to a preset merging manner;
wherein the preset merging manner is configured to indicate the number of initial ammunition items required for merging into one first ammunition item; or
wherein in response to detecting the first touch operation on the reload control, merging the first quantity of initial ammunition items into the first ammunition item comprises:
in response to detecting the first touch operation on the reload control, merging the first quantity of initial ammunition items into a plurality of first candidate ammunition items; and
in response to detecting a third touch operation on the reload control, merging the plurality of first candidate ammunition items into the first ammunition item.

11-12. (canceled)

13. The method according to claim 1, wherein merging the first quantity of initial ammunition items into the first ammunition item corresponds to a synthesis time, and the first quantity is directly proportional to the synthesis time.

14. The method according to claim 2, wherein in response to determining that the number of initial ammunition items is less than the second preset value, and in response to detecting the second touch operation on the reload control, splitting the initial ammunition item into the second quantity of second ammunition items comprises:
in response to determining that the number of initial ammunition items is less than the second preset value, and in response to detecting the second touch operation on the reload control, displaying a second quantity selection control on the graphical user interface, wherein the second quantity selection control comprises a plurality of quantity nodes;
in response to detecting a user operation, determining a target quantity node from the plurality of quantity nodes; and
splitting, according to the second quantity corresponding to the target quantity node, the initial ammunition item into the second quantity of second ammunition items.

15. The method according to claim 14, wherein in response to detecting the second touch operation on the reload control, displaying the second quantity selection control on the graphical user interface comprises:
in response to detecting the second touch operation on the reload control, displaying a split control; and
in response to detecting a touch operation on the split control, displaying the second quantity selection control on the graphical user interface.

16. The method according to claim 15, wherein in response to detecting the user operation, determining the target quantity node from the plurality of quantity nodes comprises:
in response to detecting a swiping operation on the split control, determining the target quantity node from the plurality of quantity nodes.

17. The method according to claim 16, wherein in response to detecting the swiping operation on the split control, determining the target quantity node from the plurality of quantity nodes comprises:
in response to detecting the swiping operation on the split control, determining a candidate target quantity node from the plurality of quantity nodes;
obtaining a duration, after the candidate target quantity node is determined, of the swiping operation on the graphical user interface; and
in response to determining that a value of the duration is greater than or equal to a value corresponding to the candidate target quantity node, determining the candidate target quantity node as the target quantity node.

18. The method according to claim 15, wherein in response to detecting the second touch operation on the reload control, displaying the split control comprises:
in response to determining that a duration of the second touch operation on the reload control is longer than a preset duration, displaying the split control and switching the reload control to a cancel control; and
wherein the cancel control is configured to cancel a splitting process in response to detecting a touch operation on the cancel control.

19. The method according to claim 17, wherein the method further comprises:
displaying a node schematic diagram at a position corresponding to the candidate target quantity node; and
according to the value of the duration and the value corresponding to the candidate target quantity node, visually displaying the value of the duration in conjunction with the node schematic diagram.

20. The method according to claim 2, wherein the attack power of the second ammunition items is associated with the second quantity; and
wherein splitting the initial ammunition item into the second quantity of second ammunition items corresponds to a splitting time, and the second quantity is directly proportional to the splitting time.

21-22. (canceled)

23. A non-transitory computer-readable storage medium having a computer program stored thereon, wherein the program, when executed by a processor, implements the following operations:
obtaining the number of initial ammunition items of the virtual firearm, wherein a graphical user interface is provided by a terminal device, the graphical user interface at least partially displays a virtual scene and a reload control, and the virtual scene comprises a virtual object;
in response to determining that the number of initial ammunition items is greater than a first preset value, and in response to detecting a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and
in response to detecting a use operation on the first ammunition item, controlling the virtual firearm to interact, through the first ammunition item, with the virtual object in the virtual scene.

24. An electronic device, comprising:
one or more processors; and
a storage device, configured to store one or more programs, wherein the one or more programs, when executed by the one or more processors, enable the one or more processors to implement the following operations:
obtaining the number of initial ammunition items of the virtual firearm, wherein a graphical user interface is provided by a terminal device, the graphical user interface at least partially displays a virtual scene and a reload control, and the virtual scene comprises a virtual object;
in response to determining that the number of initial ammunition items is greater than a first preset value, and in response to detecting a first touch operation on the reload control, merging a first quantity of initial ammunition items into a first ammunition item, wherein the first quantity is less than or equal to the number of initial ammunition items, and an attack power of the first ammunition item is higher than an attack power of an initial ammunition item; and
in response to detecting a use operation on the first ammunition item, controlling the virtual firearm to interact, through the first ammunition item, with the virtual object in the virtual scene.
